(19) United States
(12) Patent Application Publication
(10) Pub. No.: US 2009/0200267 A1
(43) Pub. Date: Aug. 13, 2009

(54) INJECTION TYPE PLASMA TREATMENT APPARATUS AND METHOD

(75) Inventors: Yeon Keon Shim, Suwon (KR); Jong Moon Baek, Anyang (KR); Dong Hoon Kim, Gunpo (KR); Hae Ryong Lee, Seongnam (KR); Keun Ho Lee, Seongnam (KR)

Correspondence Address: CLAUSEN MILLER, P.C, SUITE 1600, 10S. LASALLE STREET, CHICAGO, IL, 60603, US

(73) Assignee: PSM, INC., Seongnam (KR)

(21) Appl. No.: 11/996,651

(22) PCT Filed: Jul. 26, 2005
(86) PCT No.: PCT/KR2005/002405

§ 371 Date: Apr. 22, 2008

(51) Int. Cl. B44C 1/22; H05H 1/24

(52) U.S. Cl. 216/67; 315/111.21; 427/569

(57) ABSTRACT

The present invention relates to an injection type plasma treatment apparatus. An object of the present invention is to provide an injection type plasma treatment apparatus capable of treating work pieces with a variety of areas, sizes and shapes without damages due to micro arc streamer by using a method of injecting plasma, which is generated through dielectric barrier discharge (DBD) under the normal pressure condition, toward the work pieces.

To this end, the injection type plasma treatment apparatus of the present invention comprises a power electrode plate which is provided in the reaction chamber in a state where a dielectric is formed on the power electrode plate; a ground electrode plate which is formed with a plurality of holes, defines a part of a wall of the reaction chamber, and cooperates with the power electrode plate to generate plasma therebetween when alternating current power is applied to the power electrode plate; and a gas supply unit which introduces reaction gas into the reaction chamber and injects the plasma in the reaction chamber to the outside through the holes in the ground electrode plate.

### BACKGROUND

1. Technical Field

The present invention relates to an injection type plasma treatment apparatus and method, and more particularly, to an injection type plasma treatment apparatus and method suitable for plasma treating work pieces with a variety of areas, sizes and shapes using dielectric barrier discharge (DBD) under the normal pressure condition.

2. Background Art

In general, pulsed corona discharge and dielectric barrier discharge are well known as atmospheric pressure discharge, i.e. a technique for generating plasma under the normal pressure condition. Pulsed corona discharge is s technique for generating plasma using high-voltage pulsed power, while dielectric barrier discharge is a technique for generating plasma by applying power with a frequency of several ten of Hz to several MHz to two electrodes among which at least one is covered with dielectric layer.

In atmospheric pressure discharge, increase in system pressure involves significant decrease in electron mean free path, and accordingly, extreme electric discharge conditions are required. Thus, since the existing atmospheric pressure discharge system requires a very strong electric field, a problem such as the large size of the plasma-generating power supply created. Therefore, a technique for easily and inexpensively generating plasma in large quantities under the atmospheric pressure is needed.

As an atmospheric pressure plasma treatment technique using a dielectric barrier discharge (DBD) technique, U.S. Pat. No. 5,124,174 issued to Uchiyama et al. discloses a technique for imparting hydrophilic nature to surfaces of a work piece to be treated by placing the work piece between opposing plate electrodes and creating the dielectric barrier discharge under the atmospheric pressure using an inert gas. Further, U.S. Pat. No. 5,414,324 issued to Roth et al. discloses a technique for changing the conditions such as electrode spacing and composition of gas for generating atmospheric plasma to improve the discharge condition, U.S. Pat. No. 6,249,400 discloses an atmospheric plasma apparatus employing tubular electrodes instead of plate electrodes, and Korean Patent No. 0365898 discloses a technique for treating a work piece placed between two opposing electrodes using plasma generated between the electrodes by introducing a reaction gas such as He and Ar into a reaction chamber and then causing the reaction gas to flow between the two electrodes between which a dielectric plate is placed.

An example of the aforementioned conventional techniques will be explained with reference to FIG. 1. A conventional plasma treatment apparatus 100 includes a reaction chamber 110 in which two opposing electrodes 120 and 140 formed respectively with dielectrics 122 and 142 are disposed. Plasma is generated by means of discharge occurring between the two electrodes 120 and 140 and the reaction gas which is introduced into the reaction chamber 110 and then flows between the two electrodes. Therefore, a work piece T placed between the two electrodes can be plasma treated.

### Technical Problem

According to the aforementioned conventional plasma treatment apparatus, however, since the work piece should be placed between the two discharge-generating electrodes, there is a limitation in treating a work piece with great thickness, three-dimensionally complex shape or large area. Further, it is difficult to cause the two electrodes to be spaced apart from each other by several millimeters, uniform glow discharge does not occur, and a large amount of micro arc streamer is created between the two electrodes. Therefore, there is a strong probability that the work piece may be damaged. Furthermore, since a total volume of the chamber is relatively larger than a plasma generation region and a considerable amount of the gas introduced into the chamber does not contribute to the plasma generation, there are problems in that the consumption of reaction gas is large and it is difficult to rapidly supply the reaction gas.

### Technical Solution

Accordingly, an object of the present invention is to provide an injection type plasma treatment apparatus capable of treating work pieces (i.e. objects to be treated) with a variety of areas, sizes and shapes without damages due to micro arc streamer by using a method of injecting plasma, which is generated through dielectric barrier discharge (DBD) under the normal pressure condition(i.e. atmospheric pressure), toward the work pieces.

Another object of the present invention is to provide an injection type plasma treatment apparatus capable of supplying a plasma generation region with the reaction gas rapidly and without great loss, while treating work pieces with a variety of areas, sizes and shapes without damages by using plasma injected from a reaction chamber.

A further object of the present invention is to provide an injection type plasma treatment apparatus having such a structure that its electrodes can be easily cooled since all the electrodes defining a plasma generation region are exposed to the outside of the reaction chamber.

### SUMMARY

According to an aspect of the present invention for achieving the aforementioned objects, there is provided an injection type plasma treatment apparatus for generating plasma in a reaction chamber and injecting the generated plasma to a work piece, which comprises a power electrode plate which is provided in the reaction chamber in a state where a dielectric is formed on the power electrode plate; a ground electrode plate which is formed with a plurality of holes, defines a part of a wall of the reaction chamber, and cooperates with the power electrode plate to generate plasma therebetween when alternating current power is applied to the power electrode plate; and a gas supply unit which introduces reaction gas into the reaction chamber and injects the plasma in the reaction chamber to the outside through the holes in the ground electrode plate.

Preferably, the gas supply unit includes a gas injection port provided in a plasma generation region between the power and ground electrode plates to introduce the reaction gas directly into the plasma generation region.

More preferably, the gas injection port is provided adjacent to the power electrode plate and faces the underlying plasma generation region. Alternatively, the gas injection port may be provided at a side wall of the reaction chamber and faces the side plasma of generation region.

Further, the power electrode plate may be provided on an upper wall of the reaction chamber and the ground electrode plate may be provided on a lower wall of the reaction chamber, whereby the plasma generation region is defined between the upper and lower walls of the reaction chamber. Furthermore, the power electrode plate may be exposed to the outside on the upper wall and cooled by means of air cooling or other cooling means.

In addition, a diameter of the hole is preferably determined to be equal to or less than 5 times of electrode spacing between the power and ground electrode plates. More preferably, the diameter of the hole is determined to be 3 to 5 times greater than the electrode spacing between the power and ground electrode plates. Further, a distance between the ground electrode plate and the work piece is preferably determined to be equal to or less than 25 times of a diameter of the hole. More preferably, the distance between the ground electrode plate and the work piece is determined to be 15 to 25 times greater than the diameter of the hole. Preferably, the electrode spacing between the ground and power electrode plates is determined to be within a range of 0.03 to 45 mm. More preferably, the diameter of the hole is determined to be within a range of 0.01 to 9.0 mm. Furthermore, the diameter of the hole may be increased in a direction from the reaction chamber toward the work piece. This enables the plasma injected through the holes in the ground electrode plate to be uniformly and widely diffused onto the work piece.

According to another aspect of the present invention, there is provided a plasma treatment method, comprising the steps of causing discharge between power and ground electrode plates and generating plasma in a reaction chamber; introducing reaction gas into the reaction chamber to inject the plasma through a plurality of holes formed in the ground electrode plate; and plasma treating a work piece positioned below the ground electrode plate by using the injected plasma.

Preferably, the plasma treatment includes surface modification, Si etching, photoresist etching, sterilization, or thin film deposition. More preferably, the amount of reaction gas introduced is adjusted by means of the number of holes formed in the ground electrode plate, a diameter of the hole, and a distance between the adjacent holes. Still preferably, the diameter of the hole is determined to be equal to or less than 5 times of a distance between the power and ground electrode plates.

### THE DRAWINGS

FIG. 1 is a schematic view illustrating a plasma treatment apparatus according to the prior art.

FIG. 2 is a schematic view illustrating a plasma treatment apparatus according to an embodiment of the present invention.

FIG. 3 is a view defining parameters specifying treatment characteristics of the plasma treatment apparatus according to the present invention.

FIG. 4 is a schematic view illustrating the correlation between electrode spacing and hole diameter in the plasma treatment apparatus according to the present invention.

FIG. 5 is a graph plotting the correlation between the electrode spacing and hole diameter in the plasma treatment apparatus according to the present invention.

FIG. 6 is a schematic view illustrating the plasma treatment apparatus according to the present invention in which a secondary discharge effect occurs in the neighborhood of a ground electrode plate.

FIG. 7 is photographic views of secondary discharge occurring in the neighborhood of the ground electrode plate under a variety of conditions.

FIG. 8 is a view illustrating a shape of the ground electrode plate designed for the diffusion injection of plasma.

FIG. 9 is a graph plotting comparison results of reaction gas consumptions between the plasma treatment apparatuses according to the prior art and an embodiment of the present invention.

FIG. 10 is a schematic view illustrating a plasma treatment apparatus according to another embodiment of the present invention.

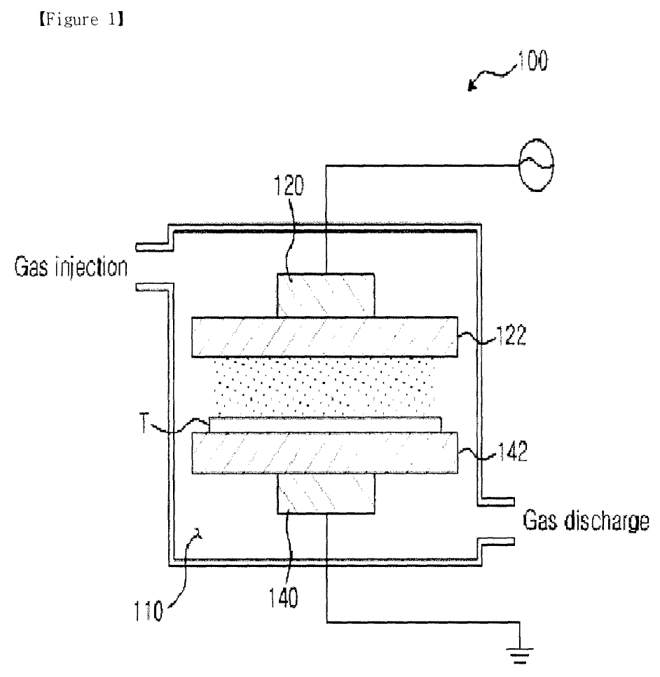

### DETAILED DESCRIPTION OF THE INVENTION

### Best Mode for Carrying Out the Invention

Hereinafter, preferred embodiments of the present invention will be described in detail with reference to the accompanying drawings.

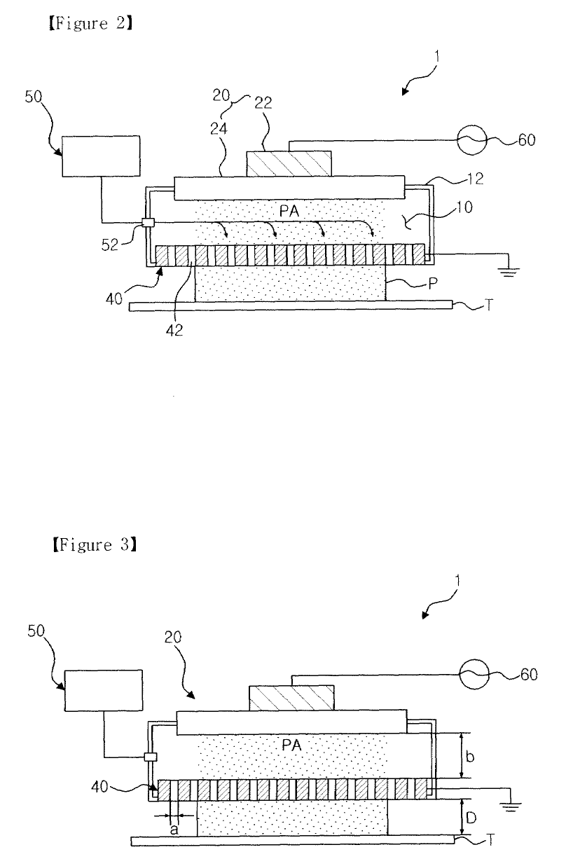

FIG. 2 is a schematic view illustrating a plasma treatment apparatus 1 according to an embodiment of the present invention.

Referring to FIG. 2, a plasma treatment apparatus 1 according to the embodiment of the present invention comprises a reaction chamber 10, power and ground electrode plates 20 and 40 provided within the reaction chamber 10, and a gas supply unit 50 for supplying a reaction gas into the reaction chamber 10.

In this embodiment, the reaction chamber 10 is constructed by a frame 12 which forms side walls and a part of an upper and/or lower wall, and the power and ground electrode plates 20 and 40 installed to the frame 12. Further, the reaction chamber 10 defines a space in which plasma is generated.

The power electrode plate 20 is an electrode that is activated by receiving high-voltage power with frequency of about 1 kHZ to 90 MHz and voltage of about 0.1 kV to 900 kV applied from an alternating current power supply 60 positioned outside of the reaction chamber 10. The power electrode plate 20 is composed of a metal conductor 22 and a dielectric 24 formed on a bottom surface of the metal conductor. At this time, the dielectric 24 may be made of oxide ceramic such as MgO, A1₂O₃, TiO₂, Pb(Zr, Ti)O₃, Si₃N₄ and PZT (Lead Zirconium Titanate) and polymer resin such as PTFE (polytetrafluoroethylen), Teflon ABS (Acrylonitrile Butadiene Styrene), PEEK (Poly Ether Ether Ketone), PC (Poly Carbonate), and PVC (Poly Vinyl Chloride). At this time, the power electrode plate 20 of the embodiment forms a part of the upper wall of the reaction chamber 10. As described in detail below, the power electrode plate can be easily cooled and allow the plasma generation region PA to be substantially the same space as the reaction chamber 10. Therefore, the unnecessary consumption of reaction gas can be prevented and the rapid supply of reaction gas into the plasma generation region can be made.

In this embodiment, the ground electrode plate 40 forms a lower wall of the reaction chamber 10 and is spaced apart from the power electrode plate 20, more specifically, the dielectric 24 on the power electrode plate 20 by a predetermined interval such that the plasma generation region PA can be defined therebetween. Further, a plurality of holes 42 are formed in the ground electrode plate 40 and face a work piece T disposed below the ground electrode plate. The plurality of holes 42 allows the plasma generated in the plasma generation region PA between the ground and power electrode plates 40 and 20 to be injected onto the work piece with the aid of the gas supply unit 50 to be explained later. Preferably, the ground electrode plate 40 is made of noble metal such as platinum (Pt), tungsten (W) and silver (Ag) from which a large amount of secondary electrons is emitted, or at least inner surface of the ground electrode plate is preferably coated with the noble metal. This facilitates easier discharge between the ground and power electrode plates 40 and 20.

In the meantime, the gas supply unit 50 allows the reaction gas to be supplied into the reaction chamber 10 through a gas injection port 52 formed in the side wall of the reaction chamber 10. The reaction gas may vary according to the kinds of work pieces T or the methods for surface treating the work piece. For example, according to which one of surface modification, Si etching, photoresist etching, sterilization or film deposition is used as a method for surface treating the work piece, N₂, O₂, Ar, He, CO₂, CO, H₂, NH₃, CF₄, CH₄, C₂H₆, air or water vapor, or a mixture thereof may be used properly.

The reaction gas supplied into the reaction chamber 10 passes through the plasma generation region PA in the reaction chamber 10 and is injected to the outside through the plurality of holes 42 formed in the ground electrode plate 40. At the same time, the plasma generated in the plasma generation region PA is also injected toward the work piece placed outside of the reaction chamber 10. At this time, since the gas injection port 52 is placed between the upper wall of the reaction chamber 10 with the power electrode plate 20 formed therein and the lower wall of the reaction chamber 10 with the ground electrode plate 40 formed therein so as to easily communicate with the plasma generation region PA, the reaction gas supplied into the reaction chamber 10 can rapidly inject the plasma residing in the plasma generation region PA to the outside without loss. Although it is described that the aforementioned gas injection port 52 has been formed in the side wall of the reaction chamber 10 to directly communicate with the plasma generation region PA in the reaction chamber 10, the gas injection port 52 may be formed in the upper wall of the reaction chamber 10 adjacent to the power electrode plate 20. Even in such a case, the gas injection port 52 directly communicates with the underlying plasma generation region.

In addition, since the power electrode plate 20 is exposed to the outside through the upper wall of the reaction chamber 10, it can be easily cooled by means of external air or arbitrary cooling means. It also contributes to the prevention of the power electrode plate 20 from being overheated due to the power application thereto and the resultant electric resistance heat.

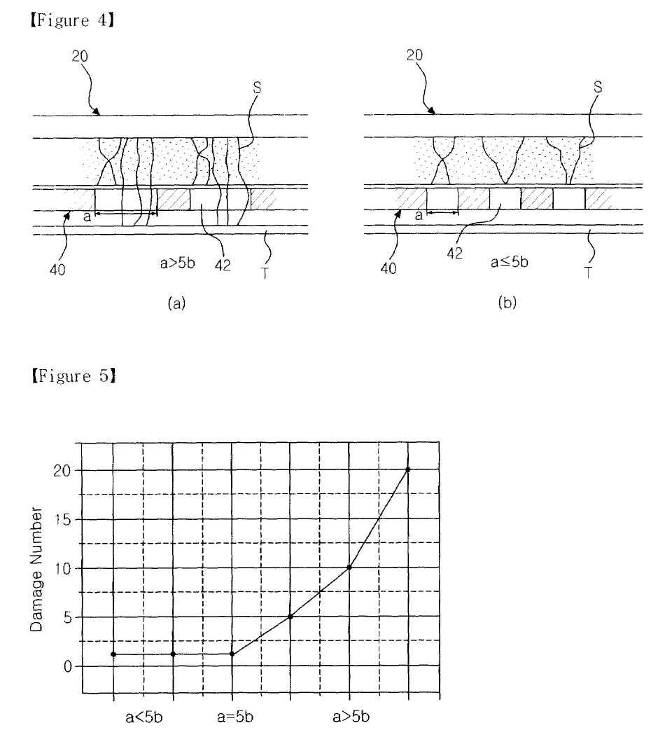

FIG. 3 is a view defining parameters that specify treatment characteristics of the plasma treatment apparatus according to the present invention. Referring to FIG. 3, “a” denotes diameter of a hole formed in the ground electrode plate 40 (hereinafter, referred to as “a hole diameter”), “b” denotes spacing between the power and ground electrode plates 20 and 40 (hereinafter, referred to as “electrode spacing”), and “D” denotes a distance between the ground electrode plate 40 and the work piece T (hereinafter, referred to as “processing distance”). The mutual relationship between the above parameters will be explained with reference to FIGS. 4 to 7.

FIGS. 4 and 5 are views illustrating the influence of the hole diameter “a” and electrode spacing “b” on the work piece T when the plasma treatment apparatus of the present invention is driven. As shown in FIGS. 4 and 5, in a case where the hole diameter “a” is 5 times greater than the electrode spacing “b” in the plasma treatment apparatus of the present invention, i.e. a>5b, the micro arc streamer S created when the plasma is generated passes through the ground electrode plate 40 and thus has influence on the underlying work piece T. In such a case, the work piece T may be damaged by the micro arc streamer. On the other hand, in a case where the hole diameter “a” is equal to or less than 5 times of the electrode spacing “b”, i.e. a≦5b, the micro arc streamer S created when the plasma is generated hardly passes through the ground electrode plate 40.

Therefore, no damages due to the arc streamer S occur in the work piece T positioned below the ground electrode plate 40. It means that the micro arc streamer S, which may be created between the electrode plates 20 and 40 to damage the work piece T, can be blocked by adjusting the hole diameter “a” and the electrode spacing “b” in the plasma treatment apparatus of the present invention. In particular, it can be verified from the tests that the micro arc streamer S has no influence on the work piece T, if the hole diameter “a” is set to be equal to or less than 5 times of the electrode spacing “b” more preferably, the diameter “a” is set to be 3 to 5 times greater than the spacing “b” in a case where the hole diameter “a” is 0.01 to 9 mm and the electrode spacing “b” is 0.03 to 45 mm.

As described above, according to the plasma treatment apparatus of the present invention, the work piece T can be prevented from being damaged by means of the micro arc streamer S by adjusting the hole diameter “a” and the electrode spacing “b”, as well as high-density radicals, ions, electrons or the like generated when the plasma is generated can be effectively utilized in the surface modification, cleaning, etching or the like of the work piece T because the plasma P generated by a strong electric field between the power and ground electrode plates 20 and 40 reaches the work piece T adjacent to the ground electrode plate 40 through the holes 42 formed in the ground electrode plate 40.

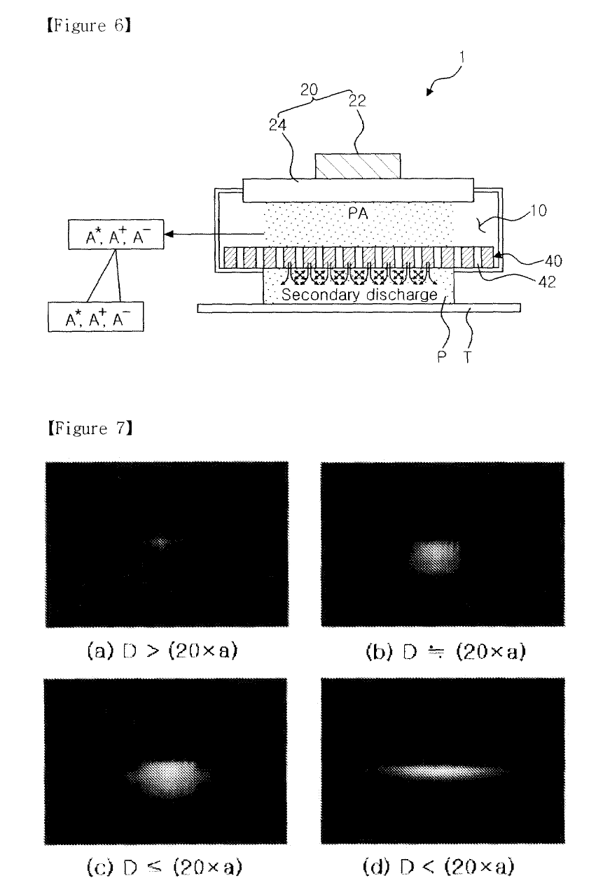

FIG. 6 is a schematic view illustrating a secondary discharge effect occurring in the plasma treatment apparatus of the present invention under the condition of the predetermined hole diameter “a” and processing distance “D”, As shown in FIG. 6, if the processing distance D, i.e. the distance between the ground electrode plate 40 and the work piece T, is maintained to be within about 25 times, more preferably 15 to 25 times, greater than the hole diameter “a” formed in the ground electrode plate 40, a secondary discharge effect is induced just below the ground electrode plate 40, which in turn causes the plasma P injected through the holes 42 in the ground electrode plate 40 to be diffused widthwise. Therefore, efficiency in which the work piece is plasma treated can be enhanced. Further, FIG. 7 shows photographic views of plasma discharge photographed while varying the distance between the work piece T and the ground electrode plate 40, i.e. the processing distance D, with respect to the fixed hole “a”, Referring to FIG. 7, it can be seen that the plasma diffusion effect is maximized as the processing distance D becomes smaller, i.e. as the work piece becomes closer to the ground electrode plate.

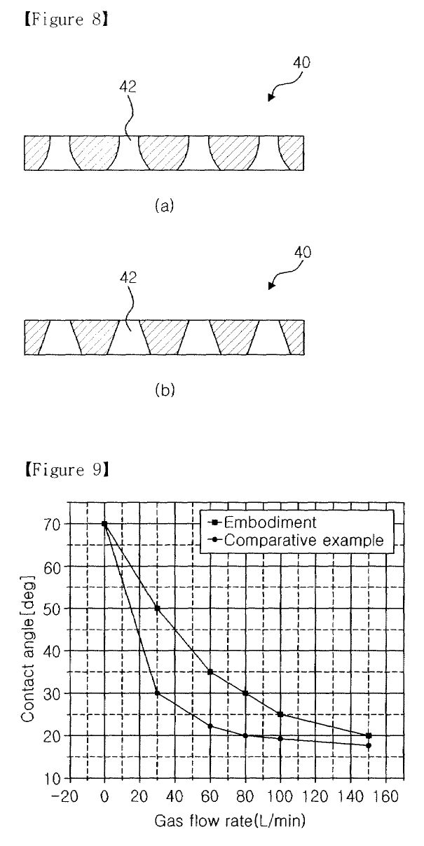

If the aforementioned secondary discharge is employed and the holes 42 in the ground electrode plate 40 are designed to have such a shape as shown in FIG. 8, the plasma diffusion effect can be further enhanced. Accordingly, more uniform plasma treatment can be made on the work piece. That is, as shown in FIGS. 8(a) and (b), the plasma diffusion effect can be further enhanced by designing the holes 42 in the ground electrode plate 40 such that their diameters are increased toward the work piece.

As described above, the plasma treatment apparatus of the present invention can easily provide the plasma treatment to the work pieces with a variety of areas, sizes and shapes without damages due to the micro arc streamer. Further, by using the configuration of FIG. 2 in which the ground electrode plate 40 having the plurality of holes 42 is formed on the lower wall of the reaction chamber 10 and the plasma P is injected through the plurality of holes 42 by means of the reaction gas, the work piece can be efficiently treated without excessive consumption of the reaction gas. In particular, since the plasma treatment apparatus 1 is configured in such a manner that the gas injection port 52 of the gas supply unit 50 is provided in the neighborhood of the plasma generation region PA, the reaction gas introduced into the reaction chamber 10 can be used for the plasma treatment in a state where the reaction gas is hardly lost. Accordingly, the consumption of the reaction gas can be more greatly reduced.

FIG. 9 is a graph showing that the conventional plasma treatment apparatus (comparative example) and the plasma treatment apparatus according to the embodiment of the present invention have been compared with each other in view of their reaction gas consumptions. FIG. 9 is a graph plotting a flow rate of the used reaction gas with respect to a contact angle to the work piece. Referring to FIG. 9, when the same amount of the plasma is treated, the plasma treatment apparatus 1 of the present embodiment utilizes the smaller flow rate of the reaction gas as compared with the comparative example. That is, it means that the smaller amount of the reaction gas can be used to generate and inject the plasma in the plasma treatment apparatus 1 of this embodiment as compared with the conventional plasma treatment apparatus.

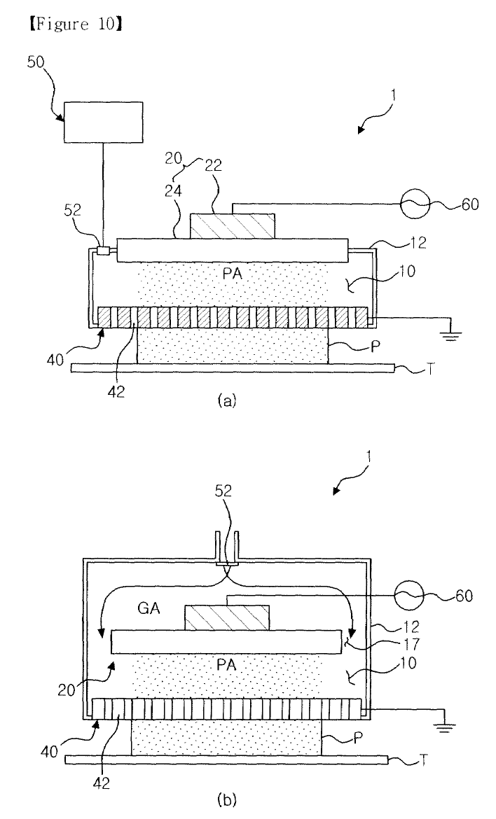

FIG. 10 is a view showing plasma treatment apparatuses according to other modified embodiments of the present invention. Referring to FIG. 10(a), a power electrode plate 20 is formed on an upper wall of a reaction chamber 10 as described in the previous embodiment, but a gas injection port 52 of a gas supply unit 50 is formed in the upper wall of the reaction chamber 10 adjacent to the power electrode plate 20 rather than in a side wall of the reaction chamber 10. A plasma treatment apparatus 1 of this embodiment has an advantage in that the consumption of reaction gas is small and the rapid supply of reaction gas can be made because the reaction gas is directly introduced into a plasma generation region similarly to the plasma treatment apparatus of the previous embodiment. Referring to FIG. 10(b), a power electrode plate 20 is formed within a reaction chamber 10, which in turn is divided into a gas supply region GA and a plasma generation region PA by means of the power electrode plate 20. Then, the reaction gas flows into the plasma generation region through a flow passage 17 defined between the power electrode plate 20 and a side wall of the reaction chamber 10.

A plasma treatment apparatus with the power electrode plate formed on an upper wall of a reaction chamber as illustrated in FIG. 2 or FIG. 10(a) is better than a plasma treatment apparatus with the power electrode plate formed within the reaction chamber as illustrated in FIG. 10(b), because the former has advantages in that the consumption of reaction gas is smaller, the reaction gas can be supplied more rapidly, and the cooling of the power electrode plate is made more easily, in comparison with the latter.

Although it has been illustrated in FIGS. 2 and 10 that a single gas injection port 25 is connected to the reaction chamber 10, it is only an example. It is apparent that a plurality of gas injection ports 52 can be connected to the reaction chamber 10. Further, although it has been described in the previous embodiments that the holes formed in the ground electrode plate 40 are shaped as a circle, the holes may take the shape of triangle, rectangle, slit or the like.

### INDUSTRIAL APPLICABILITY

As described above, the plasma treatment apparatus of the present invention is configured such that the work piece is placed below the ground electrode plate having a plurality of holes. Therefore, there is an advantage in that the work piece can be easily plasma treated at high throughput even though it has great thickness, three-dimensionally complex shape or large area.

Further, the present invention is configured such that the gas injection port of the gas supply unit directly communicates with the plasma generation region. Therefore, there is another advantage in that the unnecessary consumption of reaction gas can be reduced and the rapid supply of reaction gas into the plasma generation region can be made.

In addition, the present invention is configured such that electrode plates, and specifically, the power electrode plate are exposed to the outside of the reaction chamber. Therefore, there is a further advantage in that the overheating of the power electrode plate due to electric resistance heat can be greatly reduced.

Furthermore, there is another advantage in that the micro arc streamer which may damage the work piece can be controlled by properly designing the diameters of the holes formed in the ground electrode plate and the electrode spacing between the ground and power electrode plates.

Moreover, there is another advantage in that the plasma diffusion effect can be enhanced and more uniform and wide plasma treatment can thus also be made by properly designing the diameters of the holes formed in the ground electrode plate and the electrode spacing between the ground and power electrode plates.

We claim as our invention:

1. An injection type plasma treatment apparatus for generating plasma in a reaction chamber and injecting the generated plasma to a work piece, comprising:
a power electrode plate provided in the reaction chamber with a dielectric formed thereon;
a ground electrode plate formed with a plurality of holes and defining a part of a wall of the reaction chamber, the ground electrode plate cooperating with the power electrode plate to generate plasma therebetween when alternating current power is applied to the power electrode plate; and
a gas supply unit for introducing reaction gas into the reaction chamber and injecting the plasma in the reaction chamber to the outside through the holes in the ground electrode plate.

2. The apparatus as claimed in claim 1, wherein the gas supply unit includes a gas injection port provided in a plasma generation region between the power and ground electrode plates to introduce the reaction gas directly into the plasma generation region.

3. The apparatus as claimed in claim 2, wherein the gas injection port is provided adjacent to the power electrode plate and faces the underlying plasma generation region.

4. The apparatus as claimed in claim 2, wherein the gas injection port is provided at a side wall of the reaction chamber and faces the side plasma of generation region.

5. The apparatus as claimed in claim 2, wherein the power electrode plate is provided on an upper wall of the reaction chamber and the ground electrode plate is provided on a lower wall of the reaction chamber, whereby the plasma generation region is defined between the upper and lower walls of the reaction chamber.

6. The apparatus as claimed in claim 5, wherein the power electrode plate is exposed to the outside on the upper wall and cooled by means of air cooling or other cooling means.

7. The apparatus as claimed in claim 1, wherein a diameter of the hole is determined to be equal to or less than 5 times of electrode spacing between the power and ground electrode plates.

8. The apparatus as claimed in claim 1, wherein a distance between the ground electrode plate and the work piece is determined to be equal to or less than 25 times of a diameter of the hole.

9. The apparatus as claimed in claim 1, wherein electrode spacing between the ground and power electrode plates is determined to be within a range of 0.03 to 45 mm.

10. The apparatus as claimed in claim 1, wherein a diameter of the hole is determined to be within a range of 0.01 to 9.0 mm.

11. The apparatus as claimed in claim 1, wherein the holes are formed in the shape of a triangle, rectangle, circle or slit, and arranged on the ground electrode plate.

12. The apparatus as claimed in claim 1, wherein a diameter of the hole is increased in a direction from the reaction chamber toward the work piece.

13. A plasma treatment method, comprising the steps of:
causing discharge between power and ground electrode plates and generating plasma in a reaction chamber;
introducing reaction gas into the reaction chamber to inject the plasma through a plurality of holes formed in the ground electrode plate; and
plasma treating a work piece positioned below the ground electrode plate by using the injected plasma.

14. The method as claimed in claim 13, wherein the plasma treatment includes surface modification, Si etching, photoresist etching, sterilization, or thin film deposition.

15. The method as claimed in claim 13, wherein the amount of reaction gas introduced is adjusted by means of the number of holes formed in the ground electrode plate, a diameter of the hole, and a distance between the adjacent holes.

16. The method as claimed in claim 13, wherein a diameter of the hole is determined to be equal to or less than 5 times of a distance between the power and ground electrode plates.
